(19) United States
(12) Patent Application Publication
(10) Pub. No.: US 2018/0158603 A1
(43) Pub. Date: Jun. 7, 2018

(54) SYSTEM AND METHOD OF FORMING ADDITIVE MANUFACTURED COMPONENTS USING MAGNETIC FIELDS

(71) Applicant: General Electric Company, Schenectady, NY (US)

(72) Inventors: Tiffany Muller Craft, Simpsonville, SC (US); Archie Lee Swanner, JR., Easley, SC (US)

(21) Appl. No.: 15/367,713

(22) Filed: Dec. 2, 2016

(51) Int. Cl. H01F 41/02; B33Y 10/00; B33Y 30/00; B33Y 50/02; B33Y 70/00; B22F 3/00

(52) U.S. Cl. CPC H01F 41/0253; B33Y 10/00; B22F 3/008; B33Y 50/02; B33Y 70/00; B33Y 30/00

(57) ABSTRACT

Additive manufacturing systems are disclosed. The systems may include a build platform, and at least one magnet positioned adjacent the build platform. The magnet(s) may be configured to manipulate a magnetic powder material positioned on the build platform to form a pre-sintered component having a first geometry. The system may also include at least one sprayer nozzle positioned adjacent the build platform, where the at least one sprayer nozzle may be configured to coat the pre-sintered component formed from the magnetic powder material with a binder material. Additionally, the system may include a heated build chamber surrounding the build platform. The heated build chamber may be configured to heat the pre-sintered component to form a sintered component having a second geometry.

### CROSS-REFERENCE TO RELATED APPLICATION

This application is related to co-pending U.S. application Ser. Nos. ______, GE docket numbers 314869-1 and 314870-1, all filed on Dec. 2, 2016.

### BACKGROUND OF THE INVENTION

The disclosure relates generally to additive manufacturing, and more particularly, to additive manufacturing systems and methods of forming additive manufactured components using magnetic fields.

Components or parts for various machines and mechanical systems may be built using additive manufacturing systems. Conventional additive manufacturing systems may build such components by continuously layering powder material in predetermined areas and performing a material transformation process on each layer of the powder material until a component is built. The material transformation process may alter the physical state of each layer of the powder material from a granular composition to a solid material. The components built using these conventional additive manufacturing systems and processes have nearly identical physical attributes as conventional components typically made by performing machining processes on stock material.

Conventional additive manufacturing systems and/or conventional additive manufacturing processes typically require a large amount of time to create a final component. For example, each component is built layer-by-layer and each layer of the powder material can have a maximum thickness in order to ensure each layer of powder material undergoes a desirable material transformation when forming the component. As such, the material layering and material transformation process may be formed numerous times during the building of the component. Furthermore, each time a single layering and material transformation process is performed, additional processes must be performed to ensure the component is being built accurately, and/or according to specification. Some of these additional processes include realigning the component and/or the build plate in which the component is being built on, adjusting devices or components used to perform the material transformation process (e.g., lasers), reapplying powder material in portions of the layer being formed that require additional material, and/or removing excess powder material from the layer being formed and/or the portions of the component already built. As a result, building a component using conventional additive manufacturing systems and/or processes can take hours or even days.

### BRIEF DESCRIPTION OF THE INVENTION

A first aspect of the disclosure provides an additive manufacturing system including: a build platform; at least one magnet positioned adjacent the build platform, the at least one magnet configured to manipulate a magnetic powder material positioned on the build platform to form a pre-sintered component having a first geometry; at least one sprayer nozzle positioned adjacent the build platform, the at least one sprayer nozzle configured to coat the pre-sintered component formed from the magnetic powder material with a binder material; and a heated build chamber surrounding the build platform, the heated build chamber configured to heat the pre-sintered component to form a sintered component having a second geometry.

A second aspect of the disclosure provides a method of forming a sintered component. The method includes: manipulating a magnetic powder material, using magnetic waves, to form a pre-sintered component having a first geometry from the magnetic powder material; covering the pre-sintered component formed from the magnetic powder material with a binder material; and sintering the pre-sintered component formed from the magnetic powder material to form the sintered component having a second geometry, the second geometry substantially identical to the first geometry of the pre-sintered component.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a front view of an additive manufacturing system including a plurality of magnets and magnetic powder material according to embodiments.

FIG. 2 shows a top view of the additive manufacturing system and the magnetic powder material of FIG. 1, according to embodiments.

FIG. 3 shows a front view of the additive manufacturing system of FIG. 1, and a pre-sintered component formed from the magnetic powder of FIG. 1 material according to embodiments.

FIG. 4 shows a top view of the additive manufacturing system and the pre-sintered component formed from the magnetic powder material of FIG. 3, according to embodiments.

FIG. 5 shows a front view of the additive manufacturing system of FIG. 1, the pre-sintered component formed from the magnetic powder material of FIG. 3 and a binder material according to embodiments.

FIGS. 6-8 show a front view of the additive manufacturing system of FIG. 1 heating the pre-sintered component formed from the magnetic powder material coated in the binder material according to embodiments.

FIG. 9 shows a front view of the additive manufacturing system of FIG. 1 and a sintered component formed from the magnetic powder material according to embodiments.

FIG. 10 shows a front view of an additive manufacturing system including a heated build chamber filled with a vapor binder material according to additional embodiments.

FIG. 11 shows a front view of an additive manufacturing system including a plurality of magnet and magnetic powder material according to further embodiments.

FIG. 12 shows a front view of an additive manufacturing system including a plurality of magnet arrays and magnetic powder material according to another embodiment.

FIG. 13 shows a front view of an additive manufacturing system including a plurality of magnets and magnetic powder material according to additional embodiments.

FIG. 14 shows a front view of an additive manufacturing system including a single magnet and magnetic powder material according to embodiments.

FIG. 15 shows a front view of an additive manufacturing system including a single magnet array and magnetic powder material according to embodiments.

FIG. 16 shows a flow chart of an example process for forming a sintered component, according to embodiments.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within an additive manufacturing system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure provides additive manufacturing, and more particular, the disclosure provides additive manufacturing system and methods of forming additive manufactured components using magnetic fields.

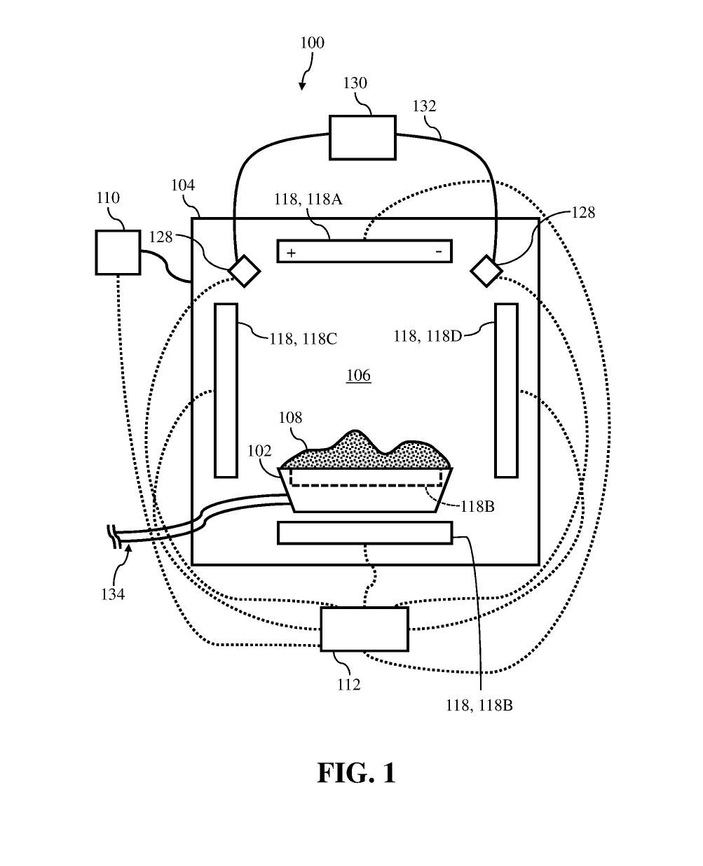

These and other embodiments are discussed below with reference to FIGS. 1-16. However, those skilled in the art will readily appreciate that the detailed description given herein with respect to these Figures is for explanatory purposes only and should not be construed as limiting.

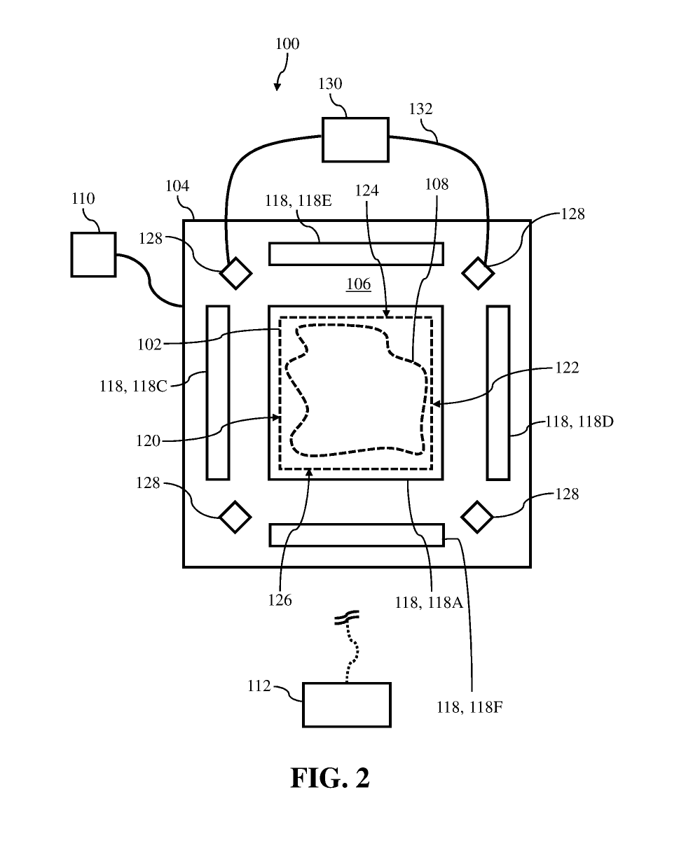

FIGS. 1 and 2 show a front and top view, respectively, of an additive manufacturing system 100. As discussed herein, additive manufacturing system 100 may utilize magnetic waves to initially manipulate powder material to form an entire component and subsequently sinter the entire component using a heat source. Additive manufacturing system 100 and the process of forming a sintered component using additive manufacturing system 100, as discussed herein, may significantly reduce a time required to build a component from powder material.

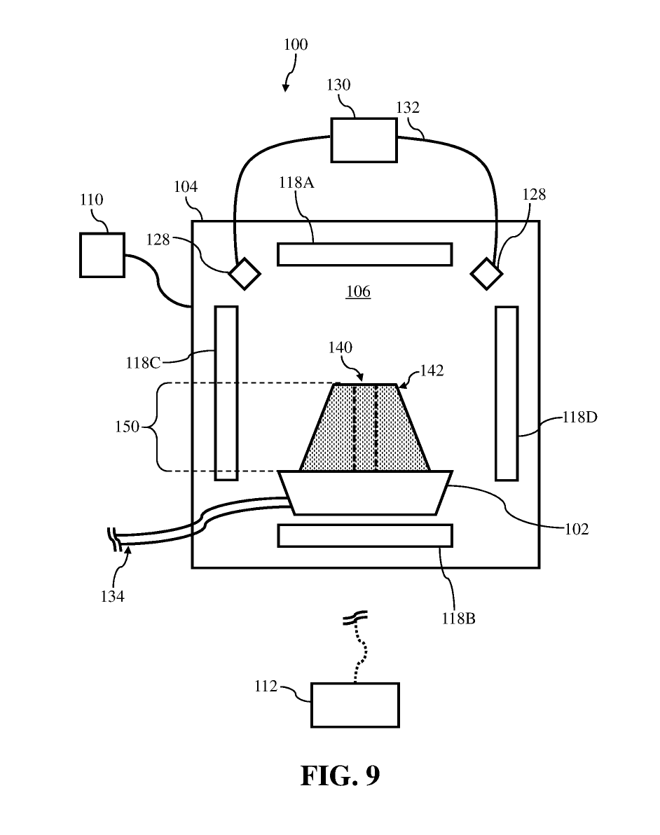

As shown in FIGS. 1 and 2, additive manufacturing system 100 (hereafter, “AMS 100”) may include a build platform 102. Build platform 102 may be positioned within a heated build chamber 104 of AMS 100. That is, build platform 102 may be positioned or disposed within a chamber or cavity 106 of heated build chamber 104, such that heated build chamber 104 may substantially surround build platform 102. Build platform 102 may include a build plate (not shown), a build surface and/or build structure for a magnetic powder material 108 that may be utilized by AMS 100 to form a sintered component. As shown in FIGS. 1 and 2 magnetic powder material 108 may be positioned within heated build chamber 104, and more specifically, may be positioned on build platform 102 of AMS 100. As discussed in detail herein, build platform 102 may receive magnetic powder material 108 and may provide a build structure for the sintered component (see, FIG. 9) formed from magnetic powder material 108 using AMS 100.

Build platform 102 may be formed from any suitable material that may receive and/or support magnetic powder material 108 and the sintered component formed from magnetic powder material 108, as discussed herein. In non-limiting examples, build platform 102 may be formed from non-magnetic, diamagnetic or paramagnetic materials to prevent or significantly reduce any magnetic attraction between build platform 102 and magnetic powder material 108 and/or any other component of AMS 100. In another non-limiting example, build platform 102 may be formed from a magnetic material (e.g., ferromagnetic material) to improve and/or influence a magnetic attraction between build platform 102 and magnetic powder material 108 and/or any other component of AMS 100. Additionally, the size and/or geometry of build platform 102 of AMS 100 may be dependent on, at least in part, the amount of magnetic powder material 108 utilized by AMS 100 to form the sintered component, the size of the sintered component and/or the geometry of the sintered component formed by AMS 100.

Magnetic powder material 108 utilized by AMS 100 may include a variety of powder materials that may include magnetic properties and/or a magnetic moment. Specifically, magnetic powder material 108 may be formed from a magnetic material that may be influenced, displaced, manipulated and/or altered by magnetic waves or energy. In non-limiting examples, magnetic powder material 108 may be formed from ferromagnetic materials including, but not limited to, iron, cobalt, nickel, metal alloys and any other suitable ferrous/magnetic material that is capable of being welded. Additionally, magnetic powder material 108 may be formed from a material that is capable of being sintered when heated. It is understood that “magnetic powder material 108” and “powder material 108” may be used interchangeably, and may refer to any powder material that includes similar material characteristics or properties, and may undergo the processes discussed herein.

As shown in FIGS. 1 and 2, heated build chamber 104 may at least partially and/or substantially surround build platform 102 and magnetic powder material 108. Specifically in non-limiting examples, heated build chamber 104 may completely surround and/or encapsulate build platform 102, or alternatively, heated build chamber 104 may only partially surround build platform 102. Heated build chamber 104 may be formed as any suitable structure and/or enclosure including build cavity 106 that may receive build platform 102, magnetic powder material 108 and/or additional components of AMS 100 that may be utilized to form a sintered component. As discussed herein, heated build chamber 104 may be heated and/or may provide heat (as a heat source) to cavity 106 including magnetic powder material 108 to form the sintered component from magnetic powder material 108. In a non-limiting example shown in FIGS. 1 and 2, heated build chamber 104 may be configured as a heat source, and may be coupled to and/or in communication with a heating component 110 that may provide energy (e.g., electricity) to heated build chamber 104 to heat cavity 106. In another non-limiting example, and discussed herein, cavity 106 and/or heated build chamber 104 may be heated and/or provided heat by placing heated build chamber 104, including all components of AMS 100 positioned within heated build chamber 104, into or adjacent a larger heating source or component.

Heated build chamber 104 may be formed from any suitable material that may be capable of withstanding high temperature (e.g., 2000° C.) and/or heating to form the sintered component from magnetic powder material 108, as discussed herein. In a non-limiting example, heated build chamber 104 may be formed from an ultra-high-temperature ceramic material. Similar to build platform 102, heated build chamber 104 may also be formed from a material having magnetic properties to improve, or alternatively, non-magnetic properties to reduce magnetic attraction between heated build chamber 104 and magnetic powder material 108. Additionally, the size and/or geometry of heated build chamber 104 may be dependent on, at least in part, the size and/or the geometry of the sintered component formed by AMS 100.

As shown in FIGS. 1 and 2, a controller 112 of AMS 100 may be in electrical communication with heating component 110 in electrical communication with heated build chamber 104. Controller 112 may be any suitable electronic device or combination of electronic devices (e.g., computer system, computer program product, processor and the like) that may be in electrical communication with heating component 110 and may be configured to adjust the operation of heating component 110. That is, controller 112 may be in electrical communication with heating component 110 and during a process of forming a sintered component using AMS 100, as discussed herein, controller 112 may be configured to activate and/or engage heating component 110 to provide energy (e.g., electricity) to heated build chamber 104 to heat cavity 106.

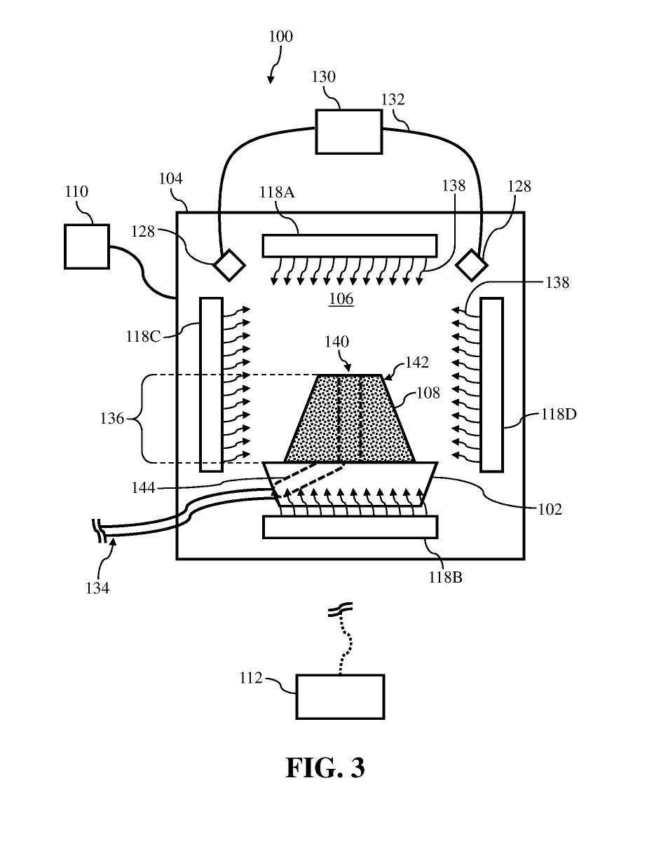

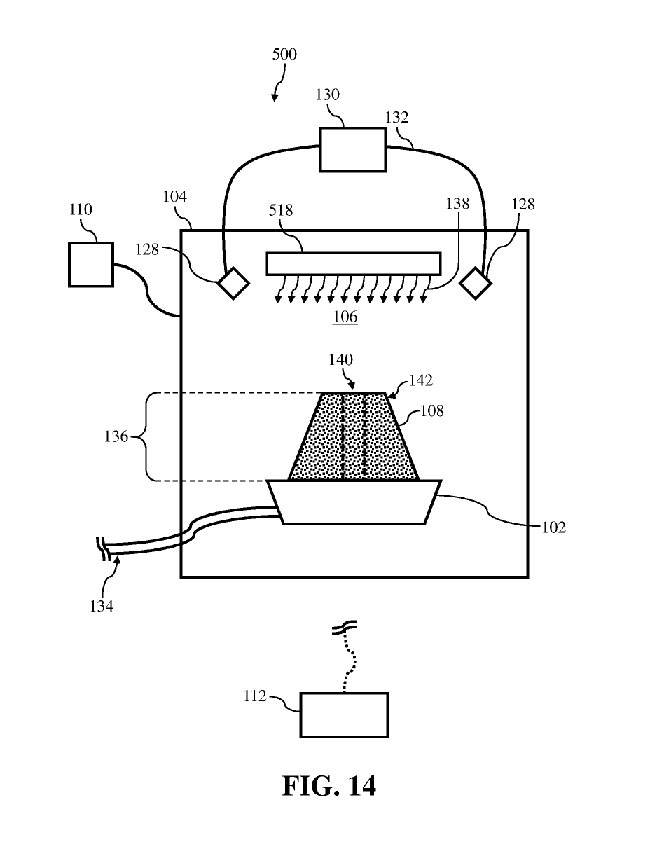

AMS 100 may also include at least one magnet 118 positioned adjacent build platform 102. As shown in the non-limiting example of FIGS. 1 and 2, AMS 100 may include a plurality of magnets 118 that may be positioned adjacent to and/or may substantially surround build platform 102. In other non-limiting examples discussed herein (see, FIGS. 14 and/or 15) AMS 100 may include a single magnet and/or single magnet array positioned adjacent to build platform 102. The plurality of magnets 118 may be positioned within heated build chamber 104, and more specifically, within cavity 106 of heated build chamber 104. In another non-limiting example, not shown, the plurality of magnets 118 of AMS 100 may be positioned outside of and substantially adjacent to heated build chamber 104. As shown in FIGS. 1 and 2, the plurality of magnets 118 may also substantially surround build platform 102 and magnetic powder material 108, respectively. As discussed herein, the positioning and/or alignment of each of the plurality of magnets 118 of AMS 100 may aid in the formation of a pre-sintered component (see, FIG. 3) from magnetic powder material 108. That is, and as discussed in detail below, each of the plurality of magnets 118 positioned within heated build chamber 104 may be configured to produce magnetic waves or fields (e.g., magnetic polarity shown on magnet 118A; FIG. 1) to manipulate magnetic powder material 108 to form a pre-sintered component within heated build chamber 104 that may be heated to form a sintered component (see, FIG. 9).

As shown in FIGS. 1 and 2, and discussed herein, the plurality of magnets 118 may substantially surround build platform 102. Specifically, AMS 100 may include a first magnet 118A positioned above build platform 102, and a second magnet 118B (see, FIG. 1) positioned below magnetic powder material 108 positioned on build platform 102. As shown in FIG. 1, second magnet 118B may be positioned opposite and/or may be substantially aligned (e.g., vertically) with first magnet 118A. In the non-limiting example shown, second magnet 118B may be positioned below build platform 102. In another non-limiting example shown in FIG. 1, second magnet 118B (shown in phantom) may be positioned, formed integral, and/or formed within build platform 102. Second magnet 118B (shown in phantom) formed within build platform 102 may be positioned below magnetic powder material 108 disposed on build platform 102 within heated build chamber 104.

The plurality of magnets 118 of AMS 100 may also include magnets 118C, 118D, 118E (see, FIG. 2), 118F (see, FIG. 2) that are positioned substantial adjacent to, in line with and/or surround build platform 102 and magnetic powder material 108, respectively. With reference to FIG. 2, magnets 118C, 118D, 118E, 118F may be positioned on distinct sides of build platform 102 and magnetic powder material 108, respectively. Specifically, third magnet 118C may be positioned adjacent a first side 120 (see, FIG. 2) of build platform 102, and fourth magnet 118D may be positioned on a second side 122 (see, FIG. 2) of build platform 102, opposite first side 120 and/or third magnet 118C. Additionally, and as shown in FIG. 2, fifth magnet 118E may be positioned adjacent a third side 124 of build platform 102, and sixth magnet 118F may be positioned on a fourth side 126 of build platform 102, opposite third side 124 and/or fifth magnet 118E. Similar to first magnet 118A and second magnet 118B, the respective magnets 118C, 118D, 118E, 118F positioned substantial adjacent to and/or surrounding build platform 102 may be positioned opposite to and/or may be substantially aligned with a corresponding magnet of the plurality of magnets 118. That is, third magnet 118C may be positioned opposite and/or may be substantially aligned (e.g., horizontally and vertically) with fourth magnet 118D, and fifth magnet 118E may be positioned opposite and/or may be substantially aligned (e.g., horizontally and vertically) with sixth magnet 118F.

It is understood that the number of magnets 118 of AMS 100 shown in the figures is merely illustrative. As such, AMS 100 may include more or less magnets 118 than the number depicted and discussed herein. Additionally, the position and/or alignment of the plurality of magnets 118 within heated build chamber 104 shown in the figures is merely illustrative. The plurality of magnets 118 may be positioned or located in various locations of heated build chamber 104. Furthermore, the position/location and/or the alignment relation of each magnet 118 may be dependent on, at least in part, the number of magnets 118 included in AMS 10, the size and/or geometry of heated build chamber 104, and/or the size and/or geometry of the sintered component to be formed using AMS 100.

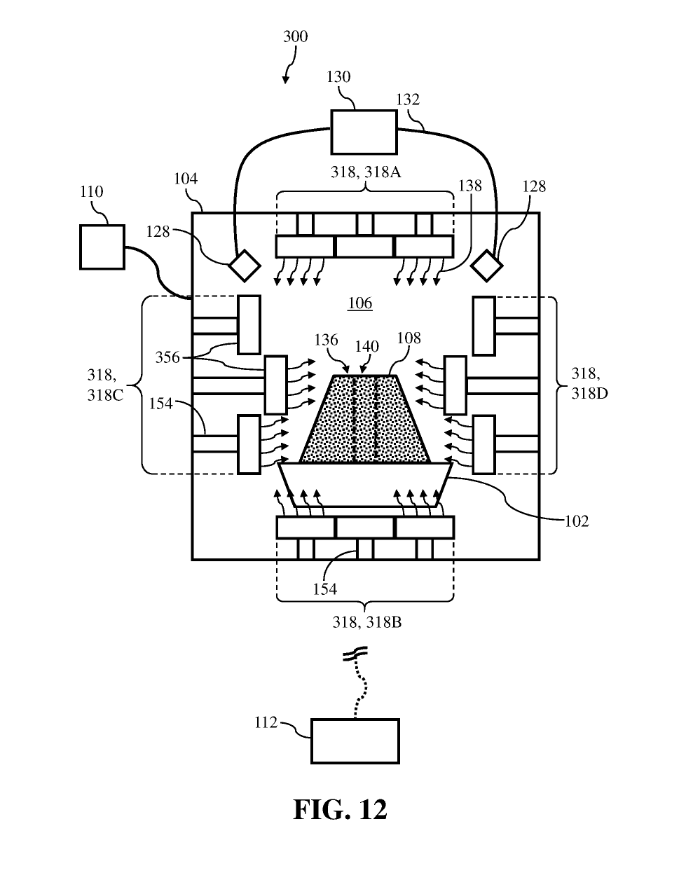

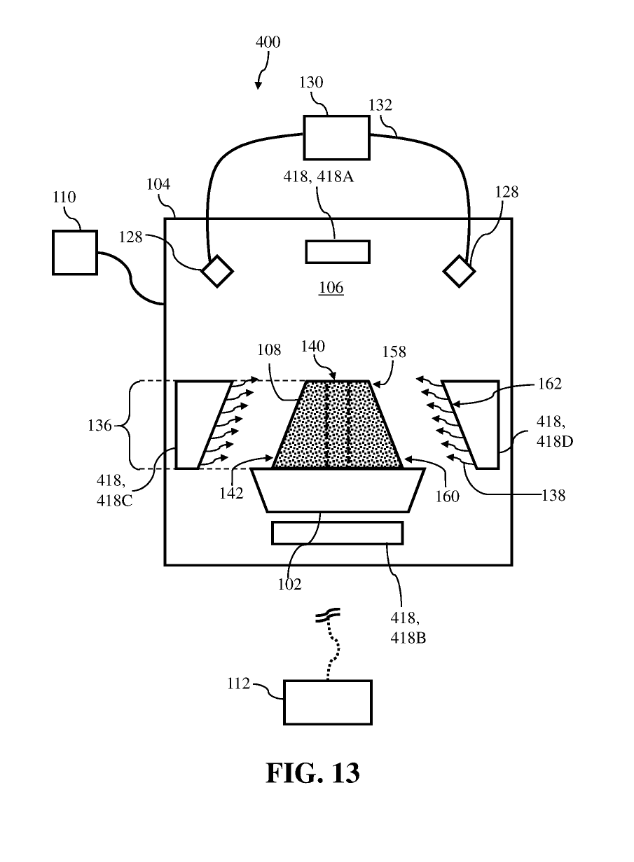

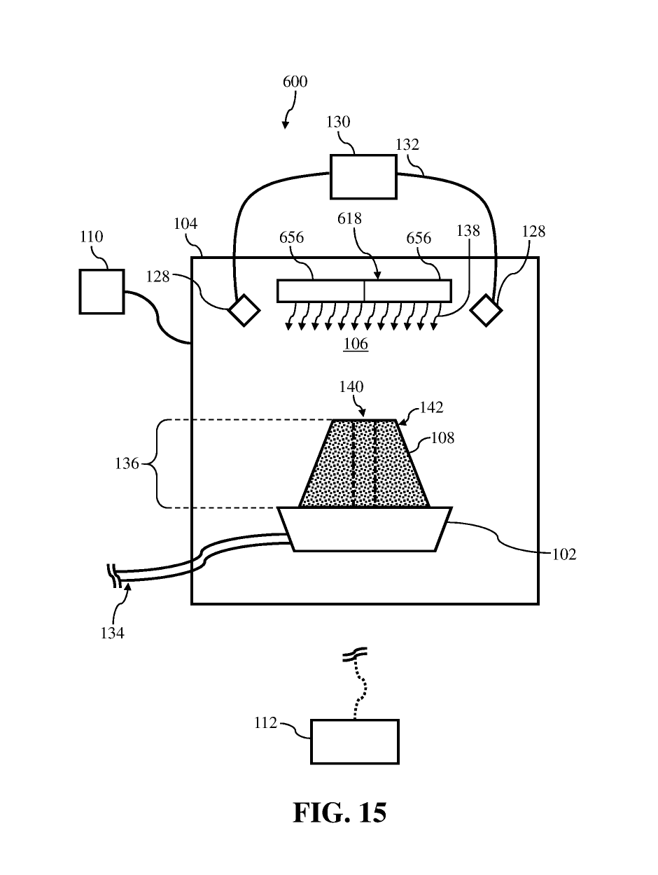

Each of the plurality of magnets 118 of AMS 100 may include a single magnet (e.g., magnetic polarity shown on first magnet 118A) configured to generate magnetic waves and/or magnetic fields. That is, each of the plurality of magnets 118 of AMS 100 may be formed from a single magnet or magnetized component that is capable of generating a magnetic wave or field. In other non-limiting examples discussed herein (see, FIGS. 12 and 15), each magnet may be formed from a magnet array and/or a plurality of magnets or magnetized components. As shown in FIGS. 1 and 2, controller 112 of AMS 100 may also be in electrical communication with each of the plurality of magnets 118. Controller 112 may be configured to adjust operational characteristics of each of the plurality of magnets 118. That is, and as discussed herein, controller 112 may adjust operational characteristics of each of the plurality of magnets 118, and more specifically, operational characteristics of the magnets or magnetized components forming each of the plurality of magnets 118. The operational characteristics of magnets 118 adjusted by controller 112 may include, but are not limited to, a magnetic polarity for each of the plurality of magnets 118, a magnetic field strength for each of the plurality of magnets 118, an activation (e.g., on or off) of each of the plurality of magnets 118, and/or a distance between the magnets 118 and magnetic powder material 108 (see, FIGS. 12 and 13). As discussed herein, the operational characteristics of the magnetic waves or fields generated by the magnets or magnetized components of each of the plurality of magnets 118, as well as the positioning/alignment of magnets 118, may cause the magnetic waves or fields to interact, collide and/or repel each other to manipulate magnetic powder material 108 to form a pre-sintered component within AMS 100 (see. FIG. 3).

AMS 100 may also include at least one spray nozzle 128. As shown in FIGS. 1 and 2, AMS 100 may include a plurality of spray nozzles 128 positioned within heated build chamber 104. Specifically, the plurality of spray nozzles 128 may be positioned within heated build chamber 104, adjacent to and/or substantially surrounding magnet 118A. Additionally, the plurality of spray nozzles 128 may be positioned adjacent to, substantially above and/or may substantially surround build platform 102 and/or magnetic powder material 108 positioned on build platform 102. In non-limiting examples, spray nozzles 128 of AMS 100 may be fixed within heated build chamber 104, or alternatively, may be positioned on a track or moveable armature and may be configured to move within heated build chamber 104. In another non-limiting example, spray nozzles 128 may be positioned partially through a sidewall and/or may be formed integral with heated build chamber 104, such that only a portion of spray nozzles 128 extends into and/or is in fluid communication with cavity 106 of heated build chamber 104.

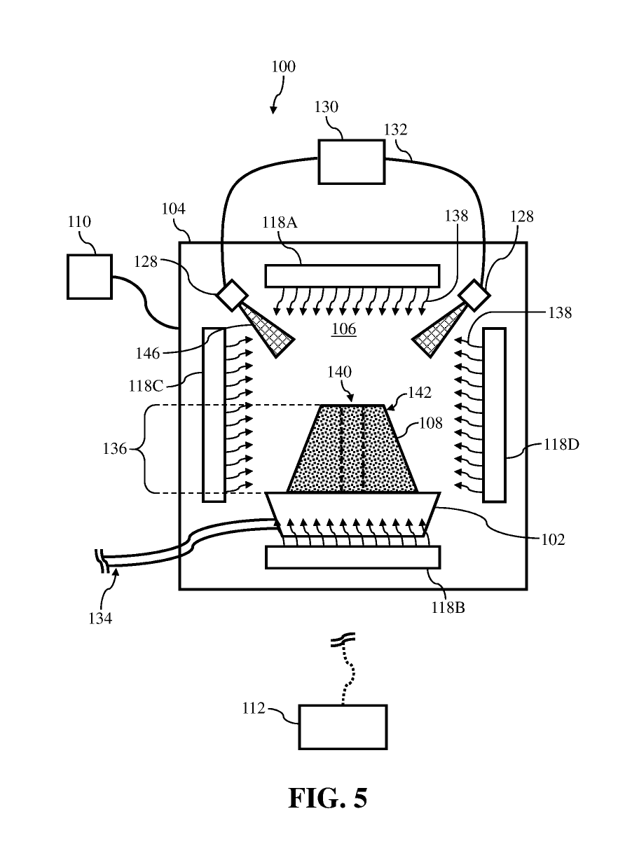

As discussed herein, spray nozzles 128 may be configured to coat a pre-sintered component made from magnetic powder material 108 with a binder material (see, FIG. 5) to maintain a geometry of the pre-sintered component during a sintering process. The binder material may be stored within a supply tank 130 of AMS 100. Supply tank 130 may be in fluid communication and/or fluidly coupled to spray nozzles 128 via conduits 132 to provide the binder material to spray nozzles 132 during the sintered component formation process discussed herein. As shown in FIGS. 1 and 2, controller 112 may be in electrical communication with each spray nozzle 128. Controller 112 may be configured to activate and/or engage spray nozzles 128 to spray and/or coat the pre-sintered component formed within heated build chamber 104 from magnetic powder material 108, as discussed herein.

It is understood that the number of spray nozzles 128 of AMS 100 shown in the figures is merely illustrative. As such, AMS 100 may include more or less spray nozzles 128 than the number depicted and discussed herein. Additionally, the position of spray nozzles 128 within heated build chamber 104 shown in the figures is merely illustrative. Spray nozzles 128 may be positioned or located in various locations of heated build chamber 104. Furthermore, the position and/or location each spray nozzle 128 may be dependent on, at least in part, the number of spray nozzles 128 included in AMS 10, the size and/or geometry of heated build chamber 104, the size and/or geometry of the sintered component to be formed using AMS 100, the composition of the binder material sprayed by spray nozzles 128 to coat the pre-sintered component and/or the ability for spray nozzles 128 to move within heated build chamber 104.

As shown in FIG. 1, AMS 100 may also include a material removal feature 134. Material removal feature 134 may be positioned within heated build chamber 104. Specifically, material removal feature 134 may be positioned within heated build chamber 104 and/or may be in (fluid) communication with cavity 106 of heated build chamber 104. Material removal feature 134 may be formed as any suitable component and/or device that may be configured to remove a non-manipulated portion of magnetic powder material 108 from heated build chamber 104 (see, FIG. 3). In a non-limiting example shown in FIG. 1, material removal feature 134 may be configured as a vacuum or a vacuum hose positioned on build platform 102 that may remove magnetic powder material 108 from build platform 102 and ultimately heated build chamber 104, as discussed herein. The non-manipulated portion of magnetic powder material 108 may be removed from heated build chamber 104 to prevent damage to the sintered component (see, FIG. 9) and/or prevent undesirable geometries or features from being formed on the sintered component during the formation process discussed herein.

A process for forming a sintered component form magnetic powder material 108 using AMS 100 may now be discussed with reference to FIGS. 3-9. It is understood that similarly numbered and/or named components may function in a substantially similar fashion. Redundant explanation of these components has been omitted for clarity. Additionally, controller 112 may not be shown to be in electrical communication with every magnet 118, spray nozzles 128 and/or heating component 110 as previously depicted. The communication lines from controller 112 to these various components of AMS 100 may be omitted in FIGS. 3-9 for clarity. As such, it is understood that controller 112 of AMS 100 may still be in electrical communication with magnets 118, spray nozzles 128 and/or heating component 110 as previously discussed and depicted herein with respect to FIGS. 1 and 2.

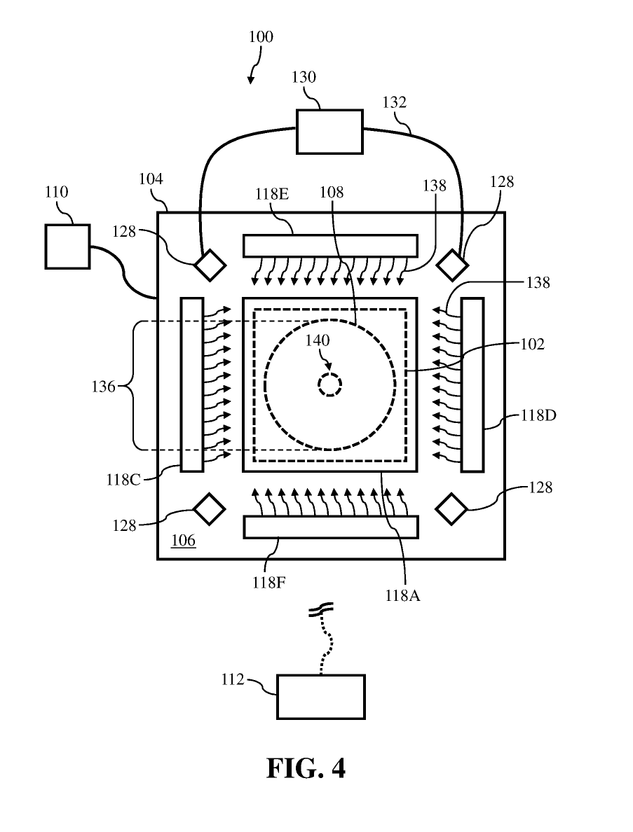

FIGS. 3 and 4 show a front and top view, respectively, of AMS 100 including magnetic powder material 108. FIGS. 3 and 4 depict a shaping, forming and/or manipulating process performed on magnetic powder material 108. That is, as shown in FIGS. 3 and 4, and distinct from FIGS. 1 and 2, AMS 100 may manipulate magnetic powder material 108 positioned on build platform 102 to form a pre-sintered component 136. Specifically, magnetic powder material 108 may be manipulated to form pre-sintered component 136 using controller 112 and the plurality of magnets 118. As shown in FIGS. 3 and 4, and discussed herein, the magnets or magnetized components forming each of the plurality of magnets 118 may generate and/or produce a magnetic wave or field 138, and may direct the magnetic field 138 toward build platform 102 to manipulate magnetic powder material 108. Controller 112 may adjust the operational characteristics of the plurality of magnets 118 to manipulate magnetic powder material 108 and form pre-sintered component 136 from the same. Adjusting the operational characteristics of the plurality of magnets 118 (see, FIGS. 1 and 2) may include activating at least a portion of the plurality of magnets 118, modifying a magnetic polarity for magnetic field 138 produced by each of the activated magnets or magnetized components of the plurality of magnets 118, and/or modifying the magnetic field strength of magnet field 138 generated by each of the activated magnets or magnetized components of the plurality of magnets 118.

Magnetic field 138 generated by each magnet or magnetized component of the plurality of magnets 118, and the adjustment to the operational characteristics of the magnets or magnetized components by controller 112, may form pre-sintered component 136. Specifically, magnetic field 138 directed toward magnetic powder material 108, and the adjusted operational characteristics for magnetic field 138, may manipulate at least a portion of magnetic powder material 108 to form pre-sintered component 136, having a geometry, on build platform 102 and/or within heated build chamber 104. The geometry of pre-sintered component 136 may be unique and/or include distinct features for the component. In a non-limiting example shown in FIGS. 3 and 4, pre-sintered component 136 may include features such as an aperture 140 formed through pre-sintered component 136, and substantially sloping or angular sidewalls 142 (see, FIG. 3). As discussed herein, the geometry and/or the features included within pre-sintered component 136 may be substantially identical to a geometry and/or features included on a sintered component (see, FIG. 9).

To form the geometry and/or features within pre-sintered component 136, magnetic fields 138 generated by each of the plurality of magnets 118 may interact, collide and/or repel each other to manipulate magnetic powder material 108. Additionally, the operational characteristics of each magnetic field 138 generated by the plurality of magnets 118 may influence and/or alter how each magnetic field 138 of each magnet 118 interacts with distinct magnet field 138 from another magnet 118, which may in turn aid in the manipulation of magnetic powder material 108. In a non-limiting example, aperture 140 of pre-sintered component 136 may be formed using first magnet 118A and second magnet 118B. In the non-limiting example, the magnets or magnetized components in each of first magnet 118A and second magnet 118B may generate magnetic fields 138 that repel each other and/or repel magnetic powder material 108 to form aperture 140 in pre-sintered component 136.

In another non-limiting example, the operational characteristics for the plurality of magnets 118, and specifically magnets 118C, 118D, 118E, 118F, may be adjusted by controller 112 to formed angular sidewalls 142. Specifically, controller 112 may adjust the magnetic field strength for each magnet 118C, 118D, 118E, 118F such that the magnetic field strength for each magnet 118C, 118D, 118E, 118F may vary (e.g., increase or decrease) based on the proximity of the magnetized component to first magnet 118A, second magnet 118B, and/or build platform 102. Additionally in other non-limiting examples, the interaction of the magnetic fields generated by the plurality of magnets 118 may be manipulated to create “magnetic dead zones” and/or voids or areas of no magnetic attraction for magnetic powder material 108. As such, no magnetic powder material 108 may be formed or positioned within these magnetic dead zones, which may result in voids, apertures, internal spaces and/or passages within pre-sintered component 136.

It is understood that the geometry and/or features for pre-sintered component 136 depicted in FIGS. 3 and 4 are merely illustrative. As such, pre-sintered component 136 may include a variety of features that are unique and/or crucial to the component being formed by AMS 100. These variety of features may be formed by adjusting any or all of the operational characteristics of the plurality of magnets 118 as discussed herein.

Additionally as shown in FIG. 3, a non-manipulated portion 144 (shown in phantom) of magnetic powder material 108 may be removed from heated build chamber 104. Specifically, material removal feature 134 of AMS 100 may remove non-manipulated portion 144 of magnetic powder material 108 from cavity 106 of heated build chamber 104. Material removal feature 134 may remove non-manipulated portion 144 of magnetic powder material 108 after pre-sintered component 136 is formed. This ensures AMS 100 has the desired and/or required amount of magnetic powder material 108 to form pre-sintered component 136 using the plurality of magnets 118. In a non-limiting example, material removal feature 134, which may be configured as a vacuum hose, may be in communication with the surface of build platform 102 in which pre-sintered component 136 is formed. After pre-sintered component 136 is formed on build platform 102, material removal feature 134 (e.g., vacuum hose) may remove (e.g., suction) non-manipulated portion 144 of magnetic powder material 108 that is not included and/or used to form pre-sintered component 136. The removal process (e.g., vacuuming or suction) may not disrupt, alter, affect and/or remove any of magnetic powder material 108 being used to form pre-sintered component 136. In the non-limiting example, the vacuum or suction force of the vacuum hose forming material removal feature 134 may not be stronger than the magnetic field strength of the plurality of magnets 118 used to manipulate magnetic powder material 108 to form pre-sintered component 106. As such, no magnetic powder material 108 may be removed from pre-sintered component 136 when vacuum hose removes or sucks non-manipulated portion 144 of magnetic powder material 108 from cavity 106. As discussed herein, non-manipulated portion 144 of magnetic powder material 108 may be removed from cavity 106 of heated build chamber 104 to prevent damage to the sintered component (see, FIG. 9) and/or prevent undesirable geometries or features from being formed on the sintered component during the formation process.

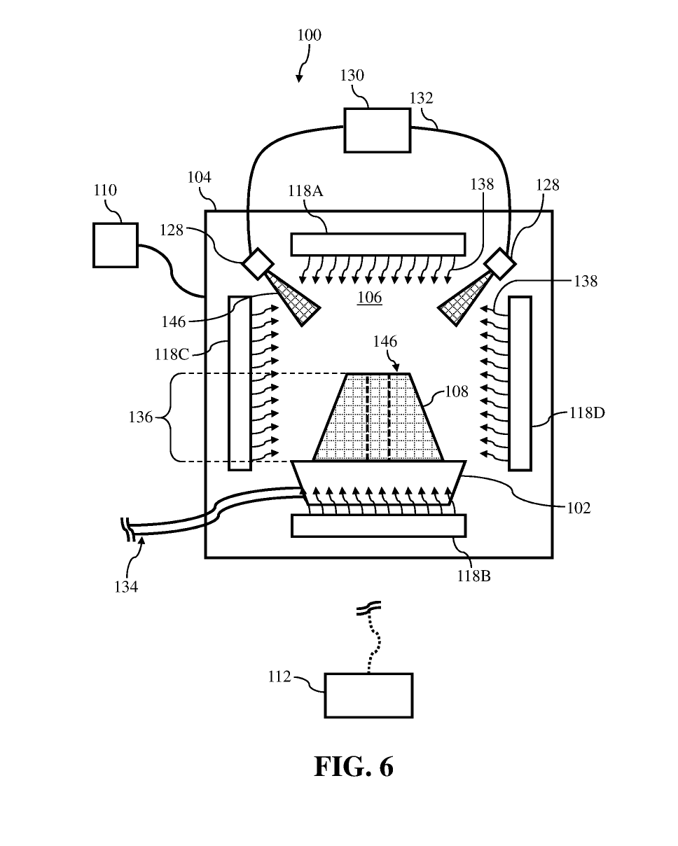

FIGS. 5 and 6 depict pre-sintered component 136 undergoing a covering or coating process. Specifically, after the manipulation of magnetic powder material 108 to form pre-sintered component 136, spray nozzles 128 of AMS 100 may cover or coat pre-sintered component 136 with a binder material 146 stored and/or supplied by supply tank 130. As discussed herein, controller 112 may be in electrical communication with and may activate spray nozzles 128 to cover or coat pre-sintered component with binder material 146 (see, FIG. 6). In a non-limiting example, spray nozzles 128 of AMS 100 may cover or coat pre-sintered component 136 by spraying a liquid binder material 146 directly on pre-sintered component 136 formed from magnetic powder material 108. Spray nozzles 128 may spray binder material 146 directly on pre-sintered component 136 to ensure all portions, geometries and/or features (e.g., aperture 140, angular sidewalls 142) of pre-sintered component 136 are coated with binder material 146. As discussed herein, spray nozzles 128 may be configured to move within heated build chamber 104 during the covering or coating process to ensure a desired or complete coverage of pre-sintered component 136 with binder material 146. Binder material 146 covering or coating pre-sintered component 136 may be any suitable binder, adhesive and/or curable material that may maintain the geometry of pre-sintered component 136 after covering or coating magnetic powder material 108 forming pre-sintered component 136. As discussed herein, covering or coating pre-sintered component 136 with binder material 146 may ensure magnetic powder material 108 maintains its shape or geometry even after pre-sintered component 146 is heated beyond a Curie temperature or Curie point for magnetic powder material 108 (e.g., temperature that magnetic powder material 108 loses its permanent magnetic properties) during a heating or sintering process.

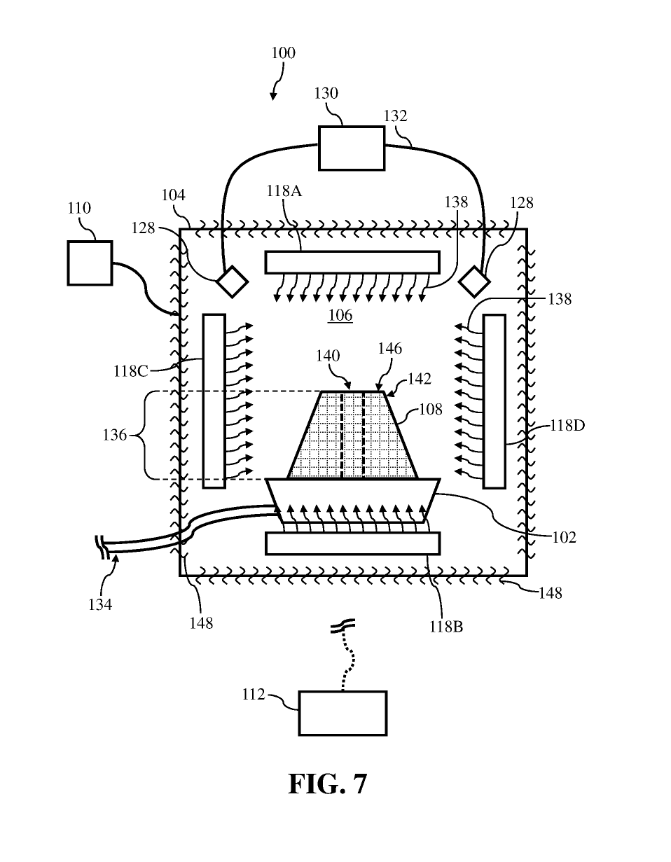

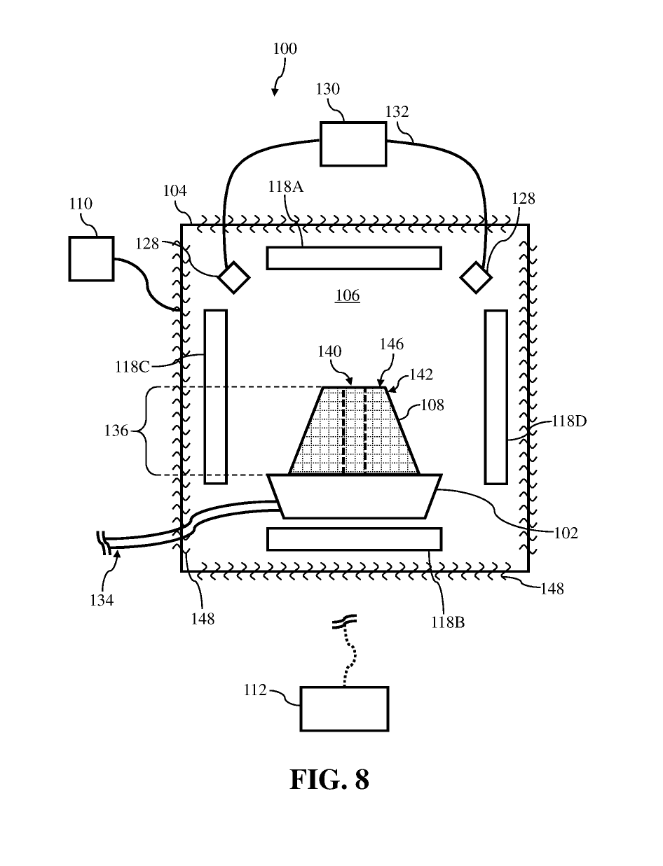

FIGS. 7-9 depict pre-sintered component 136 undergoing sintering or heating processes. FIGS. 7 and 8 may be depict various sequential processes of forming the sintered component from pre-sintered component 136, as depicted in FIG. 9. Alternatively, FIGS. 7 and 8 may depict two distinct processes of forming the sintered component from pre-sintered component 136. Each sintering or heating process shown in FIGS. 7 and/or 8 are discussed below in detail.

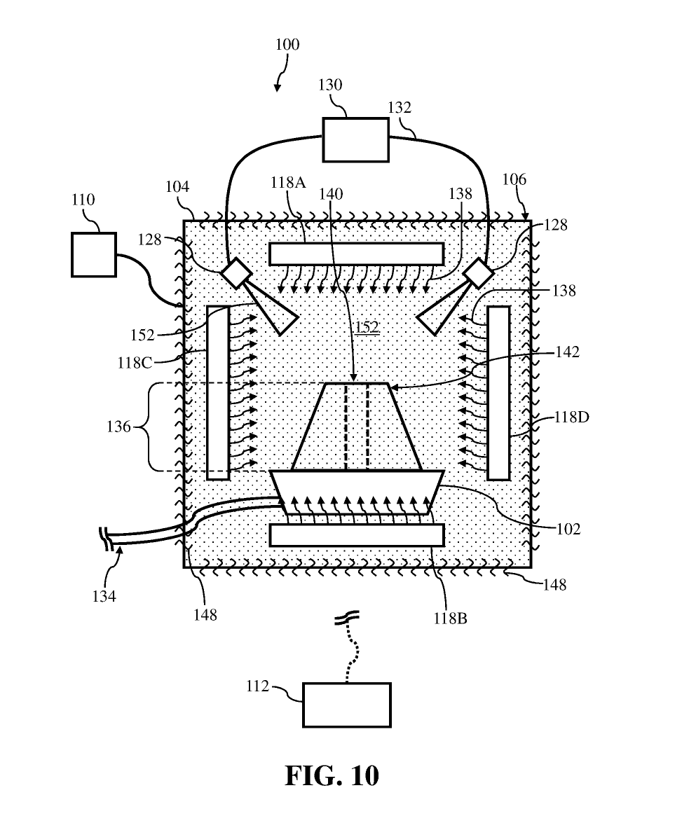

In a non-limiting example where FIGS. 7 and 8 depict sequential processes of forming the sintered component from pre-sintered component 136, pre-sintered component 136 formed from magnetic powder material 108 may be covered or coated within binder material 146, and heated build chamber 104 may subsequently produce heat 148 to heat or sinter pre-sintered component 136. As discussed herein, controller 112 may activate heating component 110 to provide energy (e.g., electricity) to heated build chamber 104, which in turn allows heated build chamber 104 to generate or produce heat 148 to heat cavity 106 and pre-sintered component 136. In another non-limiting example discussed herein, heated build chamber 104 including pre-sintered component 136 covered or coated within binder material 146 may be placed within or adjacent a larger heating source or component to produce heat 148 and/or heat cavity 106 and pre-sintered component 136. In the non-limiting example shown in FIG. 7, heated build chamber 104 may begin generating heat 148 during a sintering process of pre-sintered component 136 after spray nozzles 128 have covered or coated pre-sintered component 136 with binder material 146 and subsequently shut down or stopped spraying. Where binder material 146 is formed from a material that is affected and/or altered by heat, preforming these processes (e.g., covering then heating) as discussed herein may prevent the alteration of binder material 146 used to cover or coat pre-sintered component 136. In another non-limiting example discussed in detail herein (see, FIG. 10), heated build chamber 104 may begin to generate heat 148 and/or may begin to heat cavity 106 and pre-sintered component 136, respectively, while spray nozzles 128 continue to cover or coat pre-sintered component 136 with binder material 146.

In the non-limiting example shown in FIGS. 7 and 8, the plurality of magnets 118 of AMS 100 may remain activated and/or may continue to generate magnetic fields 138 when heated build chamber 104 begins to heat pre-sintered component 136. That is, magnetic fields 138 generated by the plurality of magnets 118 may be continually directed toward pre-sintered component 136 formed from magnetic powder material 108 after pre-sintered component 136 is covered or coated in binder material 146 and/or after heated build chamber 104 begins producing heat 148. Although it is discussed herein that binder material 146 covering or coating pre-sintered component 136 maintains the geometry of pre-sintered component 136, the plurality of magnets 118 may continue to generate magnetic fields 138 during at least a portion of the heating or sintering process to ensure or provide a precautionary measure or process and/or ensure pre-sintered component 136 maintains its geometry.

Continuing with the non-limiting example, and with reference to FIG. 8, the plurality of magnets 118 (see, FIGS. 1 and 2) may be deactivated at later time during the heating or sintering process. That is, subsequent to heated build chamber 104 beginning to produce heat 148, but prior to completely sintering or forming the sintered component (see, FIG. 9), controller 112 may deactivate or shut down operations of the plurality of magnets 118 such that the plurality of magnets 118 no longer generate magnetic fields 138 (see, FIG. 7). The plurality of magnets 118 may be deactivated or shut down by controller 112 after pre-sintered component 136 formed from magnetic powder material 108 is heated to or beyond its Curie temperature or Curie point. That is, controller 112 may deactivated or shut down the plurality of magnets 118 once pre-sintered component 136 reaches a temperature that magnetic powder material 108 loses its permanent magnetic properties and/or may no longer be manipulated by magnetic fields 138. As discussed herein, binder material 146 covering or coating pre-sintered component 136 maintains the geometry of pre-sintered component 136 while heated build chamber 104 continues to generate heat 148 to heat or sinter pre-sintered component 136.

In another non-limiting example where FIG. 7 depicts a single process of forming the sintered component (see, FIG. 9) from pre-sintered component 136, the plurality of magnets 118 may continuously generate magnetic fields 138 until magnetic powder material 108 forming pre-sintered component 136 is sintered. Distinct from the example discussed above with respect to FIGS. 7 and 8, controller 112 may maintain operation of the plurality of magnets 118 and/or the generation of magnetic fields 138 through the heating of magnetic powder material 108 to or above a Curie temperature or Curie point. As discussed herein, controller 112 may deactivate or shut down the plurality of magnets 118 only after pre-sintered component 136 has been fully sintered and/or magnetic powder material 108 has been heated to a sintering temperature for a predetermined amount of time to sinter magnetic powder material 108 forming pre-sintered component 136.

In an additional non-limiting example where FIG. 8 depicts a single process of forming the sintered component (see, FIG. 9) from pre-sintered component 136, the plurality of magnets 118 may be deactivated or shut down by controller 112 after pre-sintered component 136 is covered or coated with binder material 146. Distinct from the examples discussed above with respect to FIGS. 7 and 8, or FIG. 7 alone, controller 112 may deactivate or shut down the plurality of magnets 118, and stop the generation of magnetic fields 148 by the plurality of magnets 118, subsequent to pre-sintered component 136 being covered or coated with binder material 146. Additionally, in the non-limiting example shown in FIG. 8, controller 112 may deactivate or shut down the plurality of magnets 118 before heated build chamber 104 produces heat 148 to being heat or sinter pre-sintered component 136.

FIG. 9 depicts a front view of AMS 100 and a sintered component 150 formed by AMS 100 after performing the sintered component formation process discussed herein. Specifically, FIG. 9 depicts formed sintered component 150 after undergoing a material manipulating process (e.g., FIGS. 3 and 4), a covering or coating process (e.g., FIGS. 5 and 6) and a heating or sintering process (e.g., FIGS. 7 and/or 8) performed by AMS 100 and its various components (e.g., build platform 102, heated build chamber 104, magnets 118, and so on). As shown in FIG. 9, and with comparison to FIG. 3, magnetic powder material 108 has been sintered. As a result, the physical, chemical, material and/or mechanical properties of sintered component 150 may be distinct and/or altered from those properties of magnetic powder material 108 forming pre-sintered component 136 (see. FIG. 3). Although the properties (e.g., strength) of sintered component 150 may be distinct or different from magnetic powder material 108 forming pre-sintered component 136, the geometry of sintered component 150 may be the same or substantially identical to pre-sintered component 136. That is, sintered component 150 may include a geometry that is substantially the same or substantially identical to the geometry of pre-sintered component 136. For example, sintered component 150 may include aperture 140 and angular sidewalls 142. Once formed, sintered component 150 may be removed from heated build chamber 104 of AMS 100 and may undergo final component processing (e.g., polishing, buffing, grinding) and/or may be implemented within a system or machine that utilizes sintered component 150 during operation. In a non-limiting example, sintered component 150 may undergo a heat-treating process to remove (e.g., burn out) at least a portion of binder material 146 that may fuse and/or be formed within the sintered component 150 as a result of the covering/coating and/or sintering processes, as discussed herein.

FIG. 10 depicts another non-limiting example of AMS 100. AMS 100 depicted in FIG. 10 may utilize a vapor binder material 152 for covering or coating pre-sintered component 136. Specifically, supply tank 130 may store and/or supply a vapor binder material 152 that may be dispensed or sprayed within heated build chamber 104 by spray nozzles 128. Distinct from FIGS. 5 and 6 which depict liquid binder material 146 being sprayed directly onto pre-sintered component 136, vapor binder material 152 may be dispensed by spray nozzles 128 to fill cavity 106 of heated build chamber 104 and subsequently cover or coat pre-sintered component 136. That is, vapor binder material 152 may be dispensed into, may flood and/or fill heated build chamber 104 and may subsequently cover/coat and help maintain the geometry of pre-sintered component 136 during a heating or sintering process, as discussed herein.

FIG. 10 also depicts additional or alternative non-limiting processes for forming sintered component 150 (see, FIG. 9) using AMS 100. For example as shown in FIG. 10, heated build chamber 104 may begin producing heat 148 as vapor binder material 152 is coating or covering pre-sintered material 136. That is, as spray nozzles 128 are dispensing vapor binder material 152 within cavity 106 to coat or cover pre-sintered material 136, heated build chamber 104 may simultaneously produce heat 148 to begin heating or sintering pre-sintered material 136. In another non-limiting example, heated build chamber 104 may begin producing heat 148 prior to spray nozzle 128 dispensing vapor binder material 152 to coat or cover pre-sintered material 136. In either example, heated build chamber 104 may begin generating heat 148 prior to, or simultaneous to, spray nozzle 128 dispensing vapor binder material 152, so long as pre-sintered component 136 is not heated to the Curie temperature or Curie point for magnetic powder material 108.

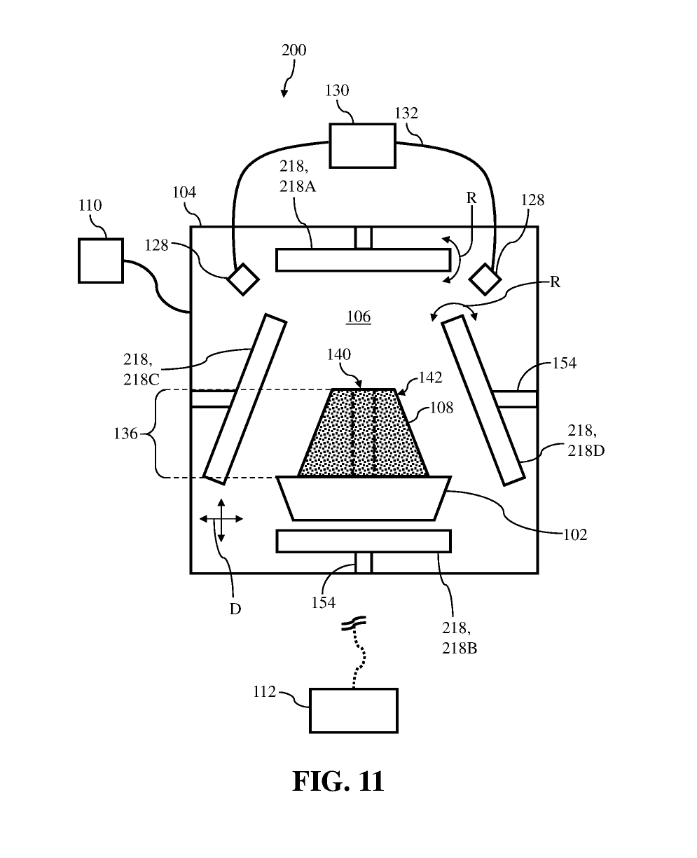

FIGS. 11-15 depict further non-limiting examples of AMS 200, 300, 400, 500, 600. Specifically, FIGS. 11-15 each depict distinct, non-limiting examples of the at least one magnet 218, 318, 418, 518, 618 of AMS 200, 300, 400, 500, 600, respectively. It is understood that similarly numbered and/or named components may function in a substantially similar fashion. Redundant explanation of these components has been omitted for clarity.

As shown in FIG. 11, each of the plurality of (single) magnets 218 may be configured to move. Specifically, each of the plurality of magnets 218 may be coupled to at least one actuator 154 (one shown) that may be configured to move each of the plurality of magnets 218 within cavity 106 of AMS 100. In the non-limiting example shown in FIG. 11, actuator 154 may be configured to move each of the plurality of magnets 218 in a linear direction (D) and/or in a rotational direction (R). The movement of each of the plurality of magnets 218 and/or the position of each of the plurality of magnets 218 with respect to build platform 102 may aid in the manipulation of magnetic powder material 108 and/or the formation of pre-sintered component 136. As such, additional operational characteristics that may be adjusted by controller 112 may include a distance between the plurality of magnets 218 and magnetic powder material 108 forming pre-sintered component 136 and/or a position of the plurality of magnets 218 within heated build chamber 104. For example, controller 112 may angle or rotate magnets 218C, 218D, 218E (not shown), 218F (not shown) in a direction (R) to aid in the formation of angular sidewalls 142 of pre-sintered component 136.

As shown in FIG. 12, ASM 100 may each of a plurality of magnets 318 may include a plurality of individual and/or distinct magnets and/or magnetized components 356. Specifically, each magnet 318 may be configured as a magnet array formed from a plurality of distinct magnets 356. As such, and as shown in the non-limiting example of FIG. 12, “plurality of magnets 318” and “plurality of magnet arrays 318” may be used interchangeably. As similarly discussed herein with respect to FIGS. 1-9, each individual magnet 356 forming each of the plurality of magnets 318 of AMS 100 may be configured to generate its own magnetic wave and/or magnetic field, and controller 112 of AMS 100 may be in electrical communication with each individual magnet 356 of the plurality of magnets 318 to control operational characteristic(s). As shown in FIG. 12, and similarly discussed herein with respect to FIG. 11, each magnet 356 of each magnet array 318 may be coupled to actuator 154 and may be configured to move in a linear direction (D) and/or a rotational direction (R). As a result, controller 112 may not only be configured to adjust the operational characteristics (e.g., magnetic field polarity, magnetic field strength) of each individual magnet 356 of each of the plurality of magnet arrays 318, but controller 112 may also be configured to adjust operational characteristics (e.g., distance, position) of each individual magnet 356 as well.

As discussed herein, adjusting the operational characteristics of each individual magnet 356 of magnet arrays 318 may aid in the manipulation of magnetic powder material 108 and/or the formation of pre-sintered component 136. Each magnet 356 of a portion of magnets 356 forming magnet arrays 318 may have its operational characteristic(s) adjusted by controller 112 to form pre-sintered component 136. For example as shown in FIG. 12, a portion of magnets 356 (e.g., central magnets) forming each of first magnet 318A and second magnet 318B may not be activated by controller 112, and as such may not generate magnetic fields 138. This may result in no magnetic powder material 108 being attracted and/or manipulated within that area of pre-sintered component 136, which in turn forms the void or aperture 140 within pre-sintered component 136. In another non-limiting example, the operational characteristics for each magnet 356 forming the plurality of magnet arrays 318 may be adjusted by controller 112 to formed angular sidewalls 142. Specifically, controller 112 may adjust the magnetic field strength for each magnet 356 for magnet arrays 318C, 318D, 318E (not shown), 318F (not shown) such that the magnetic field strength for each magnet 356 of magnet arrays 318C, 318D, 318E, 318F may vary (e.g., increase or decrease) based on the proximity with respect to first magnet array 318A and second magnet array 318B, respectively. That is, the magnetic field strength for each magnet 356 of magnet arrays 318C, 318D, 318E, 318F positioned closest to first magnet 318A may be stronger than the magnet 356 of magnet arrays 318C, 318D, 318E, 318F positioned closest to second magnet 318B. The magnet 356 positioned there between may have gradually increasing magnetic field strengths as they span between second magnet array 318B and first magnet array 318A. This varying magnetic field for magnets 356 for each magnet array 318C, 318D, 318E, 318F may manipulate magnetic powder material 108 when forming pre-sintered component 136 to have a varying-shaped feature (e.g., angular sidewalls 142).

As shown in FIG. 13, at least one of the plurality of magnets 418 may include a unique geometry. Specifically, at least one of the plurality of magnets 418 of AMS 100 may include a shape, size and/or geometry that may correspond to a portion of the geometry of pre-sintered component 136. The corresponding shape, size and/or geometry of magnets 418 may aid in the manipulation of magnetic powder material 108 and/or the formation of pre-sintered component 136. In the non-limiting example shown in FIG. 13, first magnet 418A and second magnet 418B may include distinct shapes, sizes and/or geometries from each other, that may correspond to portions of pre-sintered component 136 formed by first magnet 418A and second magnet 418B, respectively. Specifically, first magnet 418A may include a shape, size or geometry that corresponds and/or correlates to a top portion 158 of pre-sintered component 136 formed adjacent first magnet 418A. Additionally, second magnet 418B may include a shape, size or geometry that corresponds and/or correlates to a bottom portion 160 of pre-sintered component 136 formed adjacent second magnet 418B. As shown in FIG. 13, top portion 158 of pre-sintered component 136 may be smaller than bottom portion 160. As such, first magnet 418A may be smaller in shape, size or geometry than second magnet 418B. Additionally in the non-limiting example shown in FIG. 13, magnets 418C, 418D, 418E (not shown), 418F (not shown) may include angled surface 162 which may correspond and/or correlate to angular sidewall 142 of pre-sintered component 136.

FIGS. 14 and 15 depict AMS 500, 600 including a single magnet and single magnet array, respectively. More specifically, FIG. 14 shows a single magnet 518 being utilized by AMS 500, and FIG. 15 shows a single magnet array 618 being utilized by AMS 600. In the non-limiting example shown in FIG. 14, single magnet 518 may be substantially similar to any one of the single magnets or magnetized components forming magnet(s) 118 discussed herein with respect to FIGS. 1-9. In the non-limiting example shown in FIG. 15, single magnet or magnet array 618 may be formed from a plurality of individual and/or distinct magnets 656 and may be substantially similar to any one of the magnet arrays 318 discussed herein with respect to FIG. 12. Single magnet 518 (see, FIG. 14) and single magnet array 618 (see, FIG. 15) may be configured to generate a magnetic field and/or magnetic waves to manipulate magnetic powder material 108 to form pre-sintered component 136, as similarly discussed herein. Redundant explanation of these components and/or their function or operation(s) has been omitted for clarity.

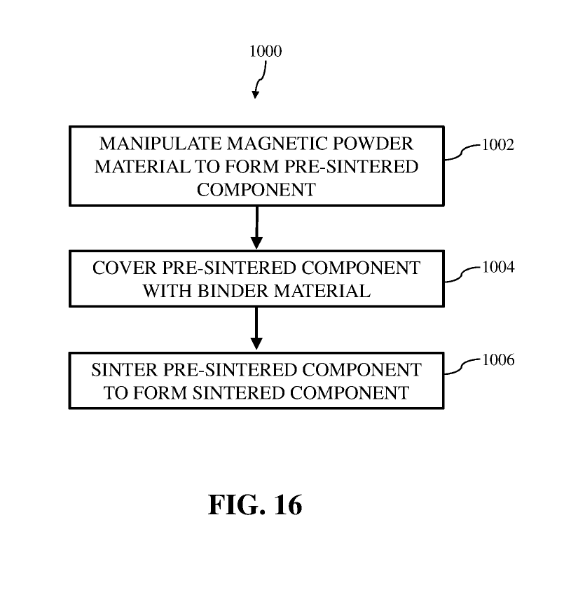

FIG. 16 shows an example process for forming a sintered component using an additive manufacturing system (hereafter, “AMS”). Specifically, FIG. 16 is a flowchart depicting one example process 1000 for forming a sintered component from a pre-sintered component using magnetic waves. In some cases, the process may be used to form sintered component 150, as discussed herein with respect to FIGS. 1-15.

In operation 1002, a magnetic powder material may be manipulated. The magnetic powder material may be manipulated using magnetic waves to form a pre-sintered component having a first geometry. Manipulating the magnetic powder to form the pre-sintered component may include adjusting operational characteristic(s) of magnet(s) or magnet array(s) of the AMS that may substantially surround and/or be positioned adjacent the magnetic powder material. Adjusting the operational characteristic(s) of magnet(s) or magnet array(s) of the AMS may include, but is not limited to, activating at least one of the plurality of magnet(s) or magnet array(s), modifying a magnetic polarity of at least one of the magnet(s) or magnet array(s), modifying a magnetic field strength of at least one of the magnet(s) or magnet array(s), changing a distance between at least one magnet or magnet array and the magnetic powder material, and/or changing a position of the at least one magnet or magnet array of the AMS.

In operation 1004, the pre-sintered component formed from the magnetic powder material may be covered or coated with a binder material. The pre-sintered component may be covered or coated with a liquid binder material, a vapor binder material or any other suitable binder, adhesive and/or curable material that may maintain the geometry of the pre-sintered component 136 after covering or coating. In a non-limiting example, covering or coating the pre-sintered component with the binder material may include spraying the binder material directly on the pre-sintered component. In another non-limiting example covering or coating the pre-sintered component with the binder material may include dispensing into or flooding a cavity containing the pre-sintered component to coat or cloak the pre-sintered material with the binder material.

In operation 1006, the pre-sintered component may be sintered to form the sintered component. Sintering the pre-sintered component may include heating the pre-sintered component using a heated build chamber surrounding the pre-sintered component. The pre-sintered component may be heated until the magnetic powder material forming the pre-sintered component is heated to its sintering temperature to form the sintered component. The sintered component formed by sintering or heating the pre-sintered component may include a second geometry, which is substantially the same or substantially identical to the first geometry of the pre-sintered component.

Although shown in FIG. 16 as being performed linearly or in succession of one another, it is understood that at least some of the operations of process 1000 may be performed in distinct order than that shown, and/or may two or more operations may be formed simultaneously. For example, heating the pre-sintered component to sinter in operation 1006 may begin prior to, or at the same time as the pre-sintered component being covered with the binder material in operation 1004.

As discussed herein, controller 112 of AMS 100 may be implemented as or on a computer device or system (hereafter “computer”). Controller 112, as described herein, executes code that includes a set of computer-executable instructions defining sintered component 150 (see, e.g., FIG. 6) to first manipulate magnetic powder material 108 to form pre-sintered component 136 having the same geometry of sintered component 150, and subsequently have heated build chamber 104 sinter pre-sintered component 136 to form sintered component 150, as discussed herein. Controller 112, or the computer including controller 112, may include a memory, a processor, an input/output (I/O) interface, and a bus. Further, the computer may be configured to communicate with an external I/O device/resource and a storage system. In general, the processor executes computer program code that is stored in the memory and/or the storage system under instructions from the code representative of sintered component 150, described herein. While executing computer program code, the processor can read and/or write data to/from the memory, the storage system, and/or the I/O device. A bus provides a communication link between each of the components in controller 112 or the computer including controller 112, and the I/O device can comprise any device that enables a user to interact with controller 112 and/or the computer (e.g., keyboard, pointing device, display, etc.).

Controller 112 or the computer including controller 112 are only representative of various possible combinations of hardware and software. For example, the processor may comprise a single processing unit, or be distributed across one or more processing units in one or more locations, e.g., on a client and server. Similarly, the memory and/or the storage system may reside at one or more physical locations. The memory and/or the storage system can comprise any combination of various types of non-transitory computer readable storage medium including magnetic media, optical media, random access memory (RAM), read only memory (ROM), etc. Controller 112 or the computer including controller 112 can comprise any type of computing device such as a network server, a desktop computer, a laptop, a handheld device, a mobile phone, a pager, a personal data assistant, etc.

Additionally, and as discussed herein, the process of forming sintered component 150 may begin with a non-transitory computer readable storage medium (e.g., memory, storage system, etc.) storing code representative of sintered component 150. As noted, the code includes a set of computer-executable instructions defining sintered component 150 that can be used to physically generate the object, upon execution of the code by controller 112 or the computer including controller 112. For example, the code may include a precisely defined 3D model of sintered component 150 and can be generated from any of a large variety of well-known computer aided design (CAD) software systems such as AutoCAD®, TurboCAD®, DesignCAD 3D Max, etc. In this regard, the code can take any now known or later developed file format. Controller 112 or the computer including controller 112 executes the code, which in turn instructs AMS 100 and its various components to form sintered component 150 using the processes discussed herein.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufacturing system comprising:
a build platform;
at least one magnet positioned adjacent the build platform, the at least one magnet configured to manipulate a magnetic powder material positioned on the build platform to form a pre-sintered component having a first geometry;
at least one sprayer nozzle positioned adjacent the build platform, the at least one sprayer nozzle configured to coat the pre-sintered component formed from the magnetic powder material with a binder material; and
a heated build chamber substantially surrounding the build platform, the heated build chamber configured to heat the pre-sintered component to form a sintered component having a second geometry.

2. The system of claim 1, wherein the first geometry of the pre-sintered component is substantially identical to the second geometry of the sintered component.

3. The system of claim 1, further comprising:
a controller in electrical communication with the at least one magnet, the controller configured to adjust an operational characteristic of the at least one magnet.

4. The system of claim 3, wherein the operational characteristic of the at least one magnet includes at least one of:
a magnetic polarity for the at least one magnet,
a magnetic field strength for the at least one magnet,
an activation of the at least one magnet, or
a distance between the at least one magnet and the magnetic powder material.

5. The system of claim 1, wherein the at least one magnet includes:
a magnet positioned on a first side of the build platform; and
a distinct magnet positioned on a second side of the build platform, opposite the first side of the build platform.

6. The system of claim 1, wherein the at least one magnet includes:
a first magnet positioned above the build platform; and
a second magnet positioned below the magnetic powder material received by the build platform.

7. The system of claim 1, wherein the binder material includes one of a liquid binder material or a vapor binder material.

8. The system of claim 1, further comprising:
a material removal feature positioned within the heated build chamber, the material removal feature configured to remove a non-manipulated portion of the magnetic powder material from the heated build chamber.

9. The system of claim 1, wherein the at least one magnet includes at least one of:
a single magnet positioned adjacent the build platform, a plurality of single magnets positioned adjacent to and substantially surrounding the build platform,
a single magnet array positioned adjacent the build platform, or
a plurality of magnet arrays positioned adjacent to and substantially surrounding the build platform.

10. The system of claim 9, wherein each magnet of at least one of the single magnet array or the plurality of magnet arrays is configured to move within the heated build chamber independent from a distinct magnet.

11. The system of claim 1, wherein the at least one magnet includes a geometry corresponding to a portion of the first geometry of the pre-sintered component.

12. A method of forming a sintered component comprising:
manipulating a magnetic powder material, using magnetic waves, to form a pre-sintered component having a first geometry from the magnetic powder material;
covering the pre-sintered component formed from the magnetic powder material with a binder material; and
sintering the pre-sintered component formed from the magnetic powder material to form the sintered component having a second geometry, the second geometry substantially identical to the first geometry of the pre-sintered component.

13. The method of claim 12, wherein manipulating the magnetic powder material further comprises:
adjusting an operational characteristic of at least one magnet positioned adjacent the magnetic powder material.

14. The method of claim 13, wherein adjusting the operational characteristics of the at least one magnet comprises at least one of:
activating the at least one magnet,
modifying a magnetic polarity for the at least one magnet,
modifying a magnetic field strength for the at least one magnet, or
changing a distance between the at least one magnet and the magnetic powder material.

15. The method of claim 12, wherein covering the pre-sintered component further comprises:
spraying a liquid binder material directly on the pre-sintered component formed from the magnetic powder material.

16. The method of claim 12, wherein covering the pre-sintered component further comprises:
dispensing a vapor binder material to coat the pre-sintered component formed from the magnetic powder material.

17. The method of claim 12, wherein sintering the pre-sintered component formed from the magnetic powder material further comprises:
heating the pre-sintered component formed from the magnetic powder material using a heated build chamber.

18. The method of claim 17, wherein heating the pre-sintered component formed from the magnetic powder material occurs subsequent to the covering of the pre-sintered component formed from the magnetic powder material with the binder material.

19. The method of claim 17, wherein heating the pre-sintered component formed from the magnetic powder material begins prior to the covering of the pre-sintered component formed from the magnetic powder material with the binder material.

20. The method of claim 19, wherein covering the pre-sintered component formed from the magnetic powder material with the binder material occurs prior to the heating of the pre-sintered component formed from the magnetic powder material to a Curie temperature of the magnetic powder material.
